(19) United States
(12) Patent Application Publication
(10) Pub. No.: US 2026/0119091 A1
(43) Pub. Date: Apr. 30, 2026

(54) MEDIUM STORING PROGRAM EXECUTABLE IN INFORMATION PROCESSING APPARATUS, AND DISPLAY METHOD

(71) Applicant: BROTHER KOGYO KABUSHIKI KAISHA, Nagoya (JP)

(72) Inventor: Shintaro KUNIMOTO, Inazawa (JP)

(21) Appl. No.: 19/340,208

(22) Filed: Sep. 25, 2025

(30) Foreign Application Priority Data
Oct. 24, 2024 (JP) 2024-187378

(51) Int. Cl. G06F 3/12; G06F 3/04842

(52) U.S. Cl. CPC G06F 3/1226; G06F 3/04842; G06F 3/1204; G06F 3/123; G06F 3/1285

(57) ABSTRACT

A non-transitory medium stores a program executable by an information processing apparatus. The program has a setting function to transmit, from the information processing apparatus, a setting command to set setting values for a plurality of items with respect to image processing apparatuses connected via a communication interface of the information processing apparatus. The program causes the information processing apparatus to perform a search process of searching for the image processing apparatuses via the communication interface, and a display process of grouping the image processing apparatuses found by the search process into a first group which supports the setting command, a second group which supports the setting command but which restricts changing a part of items settable by the setting command, and a third group which does not support the setting command, and causing a user interface of the information processing apparatus to display the grouped image processing apparatuses.

### REFERENCE TO RELATED APPLICATIONS

This application claims priority from Japanese Patent Application No. 2024-187378 filed on Oct. 24, 2024. The entire content of the priority application is incorporated herein by reference.

### BACKGROUND ART

In a known technique, an image processing apparatus, which is a target to be controlled, is selected and controlled from a management apparatus in a state that a plurality of image processing apparatuses is connected to an information processing apparatus serving as the management apparatus. For example, the following configuration is known wherein, regarding a group including a plurality of printers as members, the capabilities of the members are obtained to check whether each of the members can support all functions. In a case where any one of the functions is not supported by even one of the members, such function is disabled for the setting on a user interface screen.

### SUMMARY

The plurality of image processing apparatuses as the targets to be controlled does not necessarily have the same capability. The capability of each of the image processing apparatuses to support a control command from the management apparatus might differ among the image processing apparatuses, in some cases. The foregoing technique does not take into account of such a situation that a user is caused to recognize whether each of the image processing apparatuses can support the control command from the management apparatus. For this reason, the display mode, which relates to each of the image processing apparatuses controlled by the management apparatus, involves a margin of improvement.

According to an aspect of the present disclosure, there is provided a non-transitory medium storing a program executable by an information processing apparatus. The program has a setting function to cause the information processing apparatus to transmit a setting command with respect to a plurality of image processing apparatuses connected via a communication interface of the information processing apparatus. The setting command is a command to set setting values for a plurality of items. The program causes the information processing apparatus to perform: a search process of searching for the plurality of image processing apparatuses via the communication interface of the information processing apparatus; and a display process of grouping the plurality of image processing apparatuses found by the search process into a first group, a second group, and a third group and causing a user interface of the information processing apparatus to display the plurality of image processing apparatuses which have been grouped. Image processing apparatuses belonging to the first group support the setting command, image processing apparatuses belonging to the second group support the setting command and restrict changing at least a part of the plurality of items settable by the setting command, and image processing apparatuses belonging to the third group do not support the setting command.

Some image processing apparatuses include, for example, custom firmware which does not allow to change at least a part of the setting items. The above-described program causes the information processing apparatus to group and display the plurality of image processing apparatuses so that the above-described image processing apparatuses are distinct from the other image processing apparatuses in which the change is not restricted and the other image processing apparatuses which do not support the setting command. Accordingly, the user can recognize the presence of the image processing apparatuses in which the change is restricted.

According to another aspect of the present disclosure, there is provided a non-transitory medium storing a program executable by an information processing apparatus. The program has a setting function to cause the information processing apparatus to transmit a setting command with respect to a plurality of image processing apparatuses connected via a communication interface of the information processing apparatus. The setting command is a command to set setting values for a plurality of items. The program causes the information processing apparatus to perform: a search process of searching for the plurality of image processing apparatuses via the communication interface of the information processing apparatus; and a display process of grouping the plurality of image processing apparatuses found by the search process into a first group, a third group, and a fourth group and causing a user interface of the information processing apparatus to display the plurality of image processing apparatuses which have been grouped. Image processing apparatuses belonging to the first group support the setting command, image processing apparatuses belonging to the third group do not support the setting command, and image processing apparatuses belonging to the fourth group do not currently support the setting command but can support the setting command through an update of firmware.

Some image processing apparatuses included in the plurality of image processing apparatuses do not support the setting command due to the old firmware. Such image processing apparatuses can support the setting command through the update of the firmware. The program configured as described above groups and displays the above-described image processing apparatuses each as an image processing apparatus distinct from image processing apparatuses which support the setting command and image processing apparatuses which do not support the setting command. Accordingly, the program configured as described above can be expected to prompt the user to update the firmware with respect to the image processing apparatuses which can support the setting command through the update of the firmware.

A display method and an apparatus, each configured to realize the function of the above-described program, and a computer-readable storage medium storing the above-described program are also novel and useful.

According to the technique described in the present specification, the program capable of controlling the plurality of image processing apparatuses as well as the technique enabling the user to easily grasp whether each of the image processing apparatuses is capable of supporting the setting command are realized.

### BRIEF DESCRIPTION OF DRAWINGS

FIG. 1 illustrates a schematic configuration of an information processing apparatus which has a kitting application (device setup application) according to a first embodiment.

FIG. 2 illustrates an example of a device list display screen.

FIG. 3 is a flow chart illustrating a control procedure of a device list display process.

FIG. 4 illustrates an example of a device table.

FIGS. 5A and 5B are a flow chart illustrating a control procedure of a grouping process.

Each of FIG. 6A to FIG. 6E illustrates an example of the device list display screen.

FIG. 7 is a flow chart illustrating an example of a control procedure of a setting process.

FIG. 8 illustrates an example of a setting screen.

FIG. 9 is a flow chart illustrating an example of a control procedure of an update process.

FIG. 10 is a flow chart illustrating an example of a control procedure of a download process.

FIG. 11 is a flow chart illustrating an example of a control procedure of a starting process.

FIG. 12 illustrates a control procedure of a device list display process performed by a kitting application according to a second embodiment.

FIG. 13 illustrates an example of the device list display screen.

### DESCRIPTION

A program according to an embodiment of the present disclosure will be described in detail below, with reference to the attached drawings. The present embodiment discloses a program executable by a personal computer (hereinafter referred to as “PC”) and capable of setting the setting values for label printers connected to the PC.

### First Embodiment

### Schematic Configuration of PC

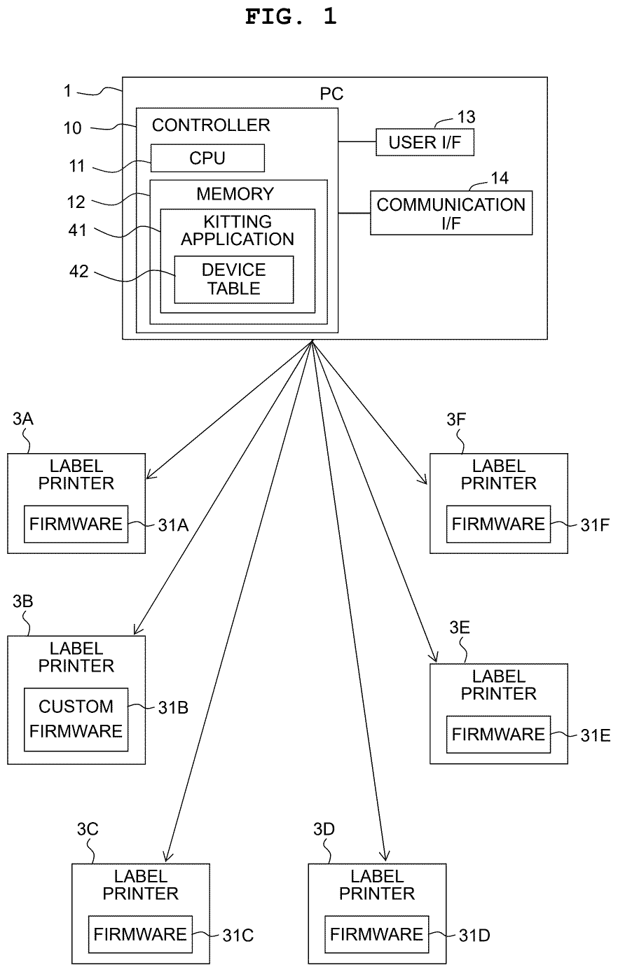

As illustrated in FIG. 1, a PC 1 according to the first embodiment includes a controller 10 which includes a CPU 11 and a memory 12. The PC 1 includes a user interface (hereinafter referred to as “user I/F”) 13 and a communication interface (hereinafter referred to as “communication I/F”) 14, and the above-described components are electrically connected to the controller 10. The PC 1 is connected to a plurality of label printers 3A, 3B, 3C, 3D, 3E, and 3F via the communication I/F 14. Each of the label printers 3A, 3B, 3C, 3D, 3E, and 3F may be, for example, a printer configured to perform printing on a cut sheet, a multi-function peripheral, a copying machine, or a scanner, under a condition that each of the label printers 3A, 3B, 3C, 3D, 3E, and 3F is an apparatus having a function to process an image. The number of apparatuses connected to the PC 1 is not limited to that described in the present embodiment. The PC 1 is an example of an “information processing apparatus”. Each of the label printers 3A, 3B, 3C, 3D, 3E, and 3F is an example of an “image processing apparatus”. In the following description, in a case where the label printers 3A, 3B, 3C, 3D, 3E, and 3F and constitutive components of the label printers do not need to be distinguished, the label printers 3A, 3B, 3C, 3D, 3E, and 3F are simply descried, for example, as the “label printer 3” or the “label printers 3”, while omitting the subscripts such as A, B, C, D, E and F from the reference numerals.

The CPU 11 performs various processes in accordance with the program read from the memory 12, or based on an operation performed by a user. Note that the controller 10 illustrated in FIG. 1 is a general term collectively referring to hardware and software used to control the PC 1, and does not necessarily refer to a single piece of hardware actually present in the PC 1.

The memory 12 of the PC 1 of the present embodiment stores various data and various programs including a kitting application program (device setup application, hereinafter referred to as “kitting application”) 41. The memory 12 is also used as a working area in a case where various processes are performed.

The CPU 11 may read the kitting application 41 from a storage medium which is readable by the CPU 11. For example, CD-ROM, DVD-ROM, and USB memories may be used as the storage medium readable by the CPU 11.

The kitting application 41 is a program provided by a vendor of the label printer 3. The kitting application 41 has a setting function to cause the PC 1 to transmit a setting command, for example, to each of the label printers 3 connected to the PC 1 via the communication I/F 14 of the PC 1. The setting command is a command to set the setting values for a plurality of items. The items include auto sleep for setting the time at which each of the label printers 3 automatically enters into a sleep state, auto power off for setting the time at which each of the label printers 3 automatically turns off the power source, and initial values of print setting (for example, orientation of printing, density of the printing, and the sheet size).

In addition to the setting function, the kitting application 41 has a monitoring function to monitor the state of each of the label printers 3, and an update function to cause the PC 1 to transmit an update command for the firmware and to update the firmware of each of the label printers 3. The kitting application 41 includes a device table 42. In the device table 42, the label printers 3 found through the search performed by the kitting application 41 are registered. The kitting application 41 is an example of a “program”. The setting command is an example of a “first control command”. The update command is an example of a “second control command”.

The user I/F 13 includes hardware configured to display a screen to notify the user of information, and hardware configured to accept an operation performed by the user. The user I/F 13 may be constructed of distinct pieces of hardware such as a keyboard and a display in which the operating function and the display function are separated from each other. Alternatively, the user I/F 13 may be constructed of one piece of hardware such as a touch panel in which the operating function and the display function are integrated into one unit.

The communication I/F 14 includes hardware to perform communication with an external apparatus. The telecommunications standard of the communication I/F 14 is, for example, Ethernet (registered trademark of FUJIFILM Business Innovation Corp.), Wi-Fi (registered trademark of Wi-Fi Alliance), and a USB. The PC 1 may include a plurality of communication I/F's 14 each corresponding to one of a plurality of telecommunications standards. The method of communication may be wired communication or wireless communication.

### Configuration of Label Printer

The label printer 3 is an apparatus configured to print an image on a long printing medium which serves as labels. For example, the label printer 3, upon receiving the setting command from the kitting application 41, performs the device settings in accordance with the setting values included in the setting command. The operation of the label printer 3 is controlled by firmware 31. In a case where the firmware 31 is updated, a function is added to the label printer 3, the label printer 3 supports a new telecommunications standard, and/or any inconvenience in the operation of the label printer 3 is corrected or improved. In a case where a function is newly added, for example, newly released sheets are added to the printable sheets, and new font data and a new template can be additionally used in the label printer 3.

The vendor of the label printers 3 may be the same as or different from the vendor who provides the kitting application 41. The versions of the firmware 31 installed in the label printers 3 may be the same or different. The firmware 31 of each of the label printers 3 may be or may not be custom firmware. The custom firmware refers to customized firmware in which a part of the functions is enabled or disabled, and in which restriction is imposed on changes with respect to at least a part of the items supported by the setting command. The restriction on the changes includes, for example, restriction on the wireless communication, prohibition of specific button operation, and fixing of a setting value. In the present embodiment, a specific letter “S” is included in the version of the custom firmware, whereas the specific letter “S” is not included in the version of the firmware which is not the custom firmware. Due to the restriction on the changes, the custom firmware does not support the update command. On the other hand, the firmware which is not the custom firmware and in which no restrictions are imposed on the changes can support the update command.

### Setting Function

Next, the setting function of the kitting application 41 will be described. Here, the setting function of the kitting application 41 will be described, with an exemplary case wherein the user uses PC 1 to perform an operation to set up the plurality of label printers 3.

### Device List Display Process

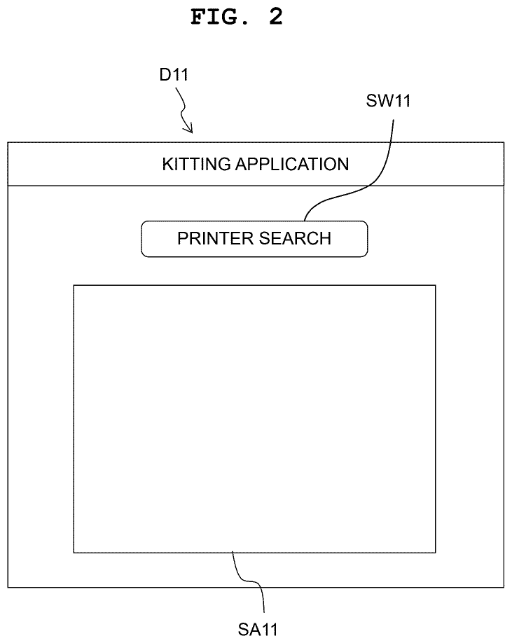

The user starts the kitting application 41, for example, after connecting the plurality of label printers 3 to the network to which the PC 1 is connected. Upon accepting a batch setting instruction on a screen provided by the kitting application 41, the CPU 11 of the PC 1 causes the user I/F 13 to display a device list display screen D11 illustrated in FIG. 2.

For example, the device list display screen D11 illustrated in FIG. 2 includes a printer search button SW11 and a device list display field SA11. The printer search button SW11 is an interactive element configured to accept a printer search instruction to search for the printers connected to the PC 1. The list of the label printers 3 found by the printer search is displayed on the device list display field SA11. Before the printer search, the device list display field SA11 is displayed as blank as illustrated in FIG. 2.

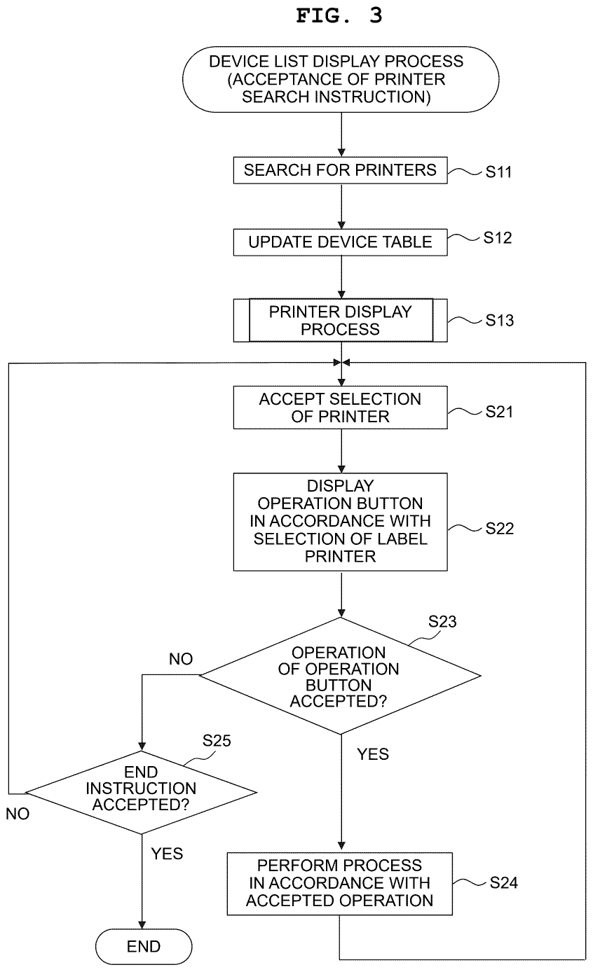

Upon accepting the printer search instruction in accordance with the operation of the printer search button SW11, the CPU 11 performs a device list display process illustrated in FIG. 3 as a process of the kitting application 41. Specifically, at first, the CPU 11 searches for the printers connected to the PC 1 using the communication I/F 14 (step S11). Step S11 is an example of a “search process”. The CPU 11 updates the device table 42 based on the label printers 3 found by the search of S11 (step S12).

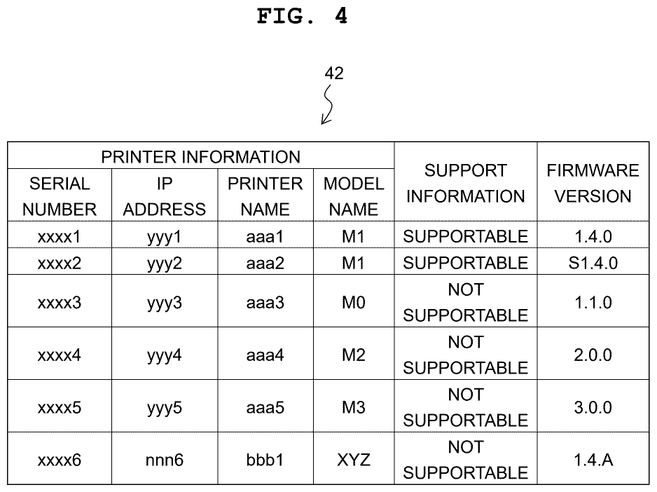

For example, the CPU 11 performs a broadcast search by using the communication I/F 14. The label printers 3, which support the kitting application 41 and which are included in the devices found by the search, are registered by the CPU 11 in the device table 42 as illustrated in FIG. 4. The CPU 11 obtains printer information including the printer name, the model name, the serial number, and the IP address from the label printers 3 found by the search. The CPU 11 stores the printer information in the device table 42 for each of the label printers 3.

The CPU 11 uses the communication I/F 14 to transmit a command corresponding to a predetermined secure level to each of the label printers 3 registered in the device table 42. In a case where the firmware 31 supports the communication at the predetermined secure level, the label printer 3 returns a response to the PC 1. On the other hand, in a case where the firmware 31 does not support the communication at the predetermined secure level, the label printer 3 does not return any response to the PC 1. The setting command is transmitted at the predetermined secure level. The CPU 11 stores the information “supportable” to indicate that the setting command is supported in the field of the support information of the device table 42, with respect to the label printer 3 from which the CPU 11 had received the response via the communication I/F 14. On the other hand, the CPU 11 stores the information “not supportable” to indicate that the setting command is not supported in the field of the support information of the device table 42, with respect to the label printer 3 from which the CPU 11 has not received the response via the communication I/F 14.

The CPU 11 requests the version of the firmware from each of the label printers 3, registered in the device table 42. Based on the response returned by each of the label printers 3, the CPU 11 stores the version of the firmware in the field of the version of the firmware provided on the device table 42.

After updating the device table 42 in step S12, the CPU 11 performs a printer display process (step S13). The printer display process is a process of displaying the search result of the printer search. The printer display process is an example of a “display process”.

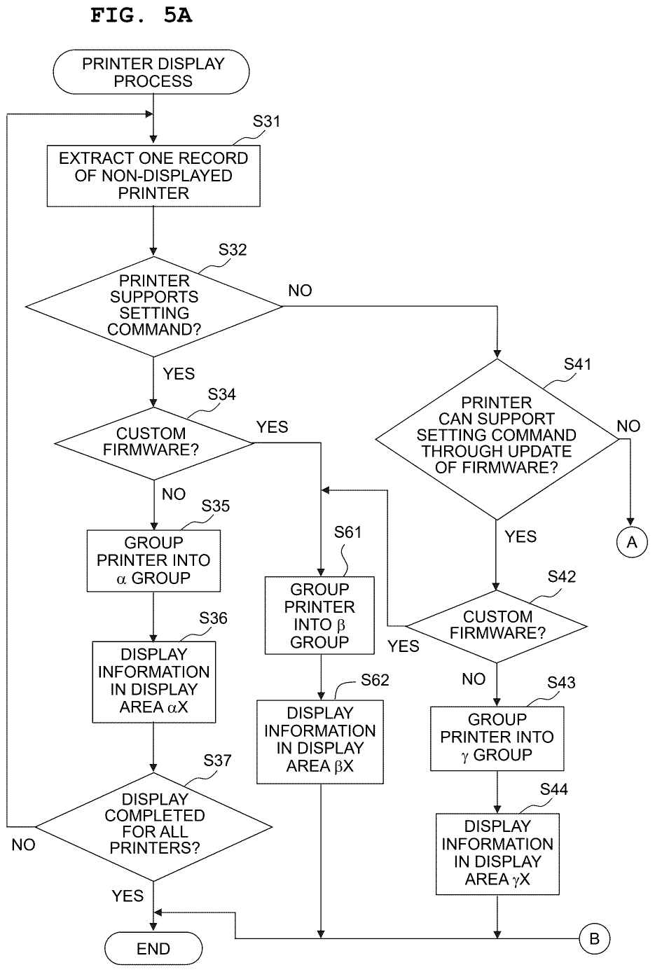

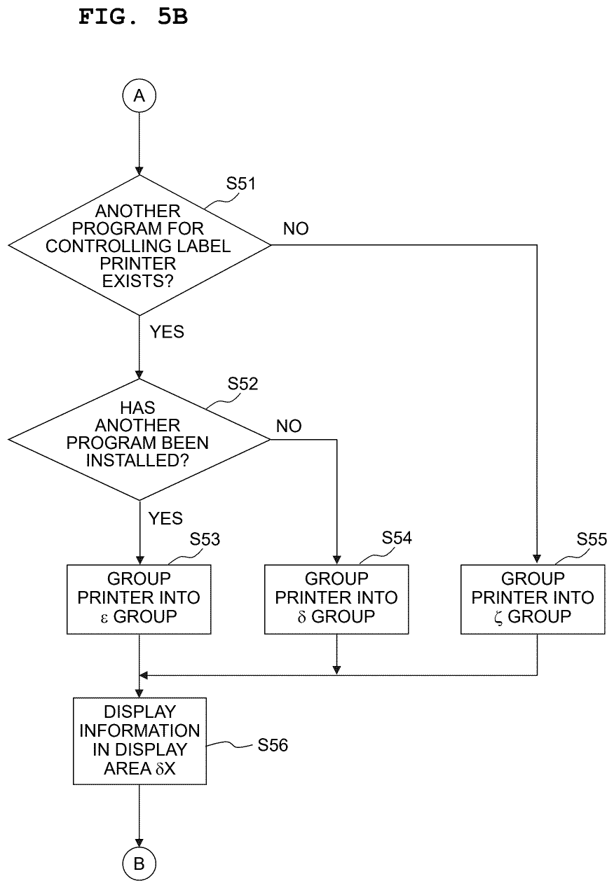

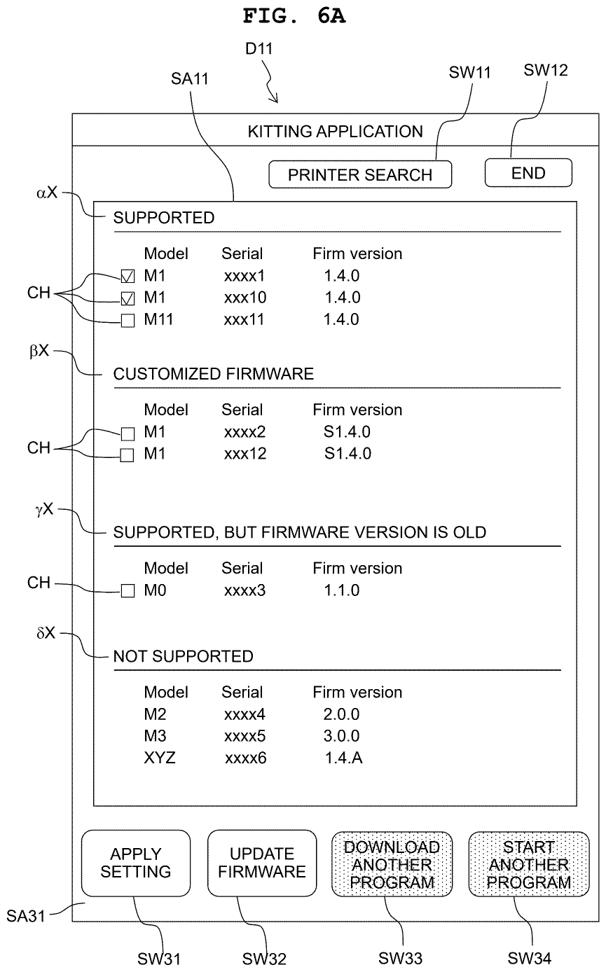

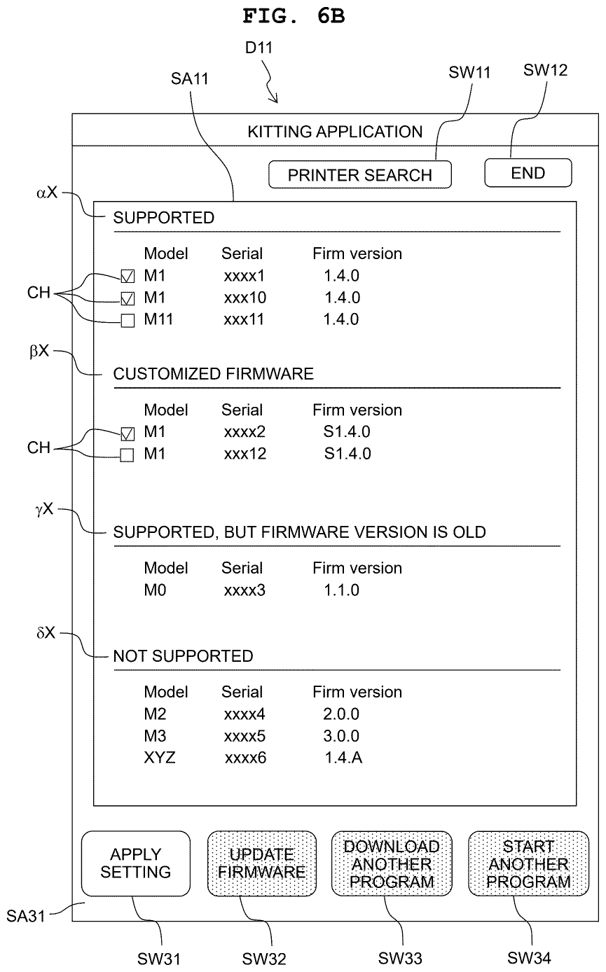

The printer display process will be described with reference to FIGS. 5A and 5B. The CPU 11 extracts, from the device table 42, a record of the label printer 3 which is not displayed in the device list display field SA11 (step S31). The CPU 11 determines whether the label printer 3 supports the setting command based on the support information of the extracted record (step S32). In a case where the CPU 11 determines that the label printer 3 supports the setting command (step S32: YES), the CPU 11 determines whether the firmware, which is currently incorporated into the label printer 3, is the custom firmware based on the version of the firmware included in the extracted record (step S34).

For example, the information on the label printer 3A is stored in the first record of the device table 42 illustrated in FIG. 4. In a case where the CPU 11 extracts the first record, the information “supportable” is stored in the support information. Therefore, the CPU 11 determines that the label printer 3A supports the setting command (step S32: YES). The version “1.4.0” of the firmware 31A included in the first record does not include the specific letter “S”. Therefore, the CPU 11 determines that the firmware 31A of the label printer 3A is not the custom firmware (step S34: NO).

In this case, the CPU 11 groups the label printer 3A into an α group (step S35). The CPU 11 displays the model name “M1” of the label printer 3A, the serial number “xxxx1”, and the version “1.4.0” of the firmware 31A in a display area αX illustrated in FIG. 6A (step S36). In the display area αX, the label printers 3A and check boxes CH are displayed one-to-one, wherein the label printers 3A can be individually selected. The α group is the group to which a label printer 3 configured to perform both the process based on the setting command and the process based on the update command belongs. The α group is an example of a “first group” and a “group A”.

After having grouped and displayed the label printers 3A, the CPU 11 determines whether the display of all of the label printers 3 registered in the device table 42 is completed (step S37), as illustrated in FIG. 5A. For example, in a case where any unprocessed record is present in the device table 42, the CPU 11 determines that the display of all of the label printers 3 is not completed (step S37: NO). In this case, the CPU 11 returns the procedure to step S31.

For example, the information on the label printer 3B is stored in the second record of the device table 42 illustrated in FIG. 4. In a case where the CPU 11 extracts the second record, the information “supportable” is stored in the support information, and the version “S1.4.0” of the firmware includes the specific letter “S”. Therefore, the CPU 11 determines that although the label printer 3B supports the setting command (step S32: YES), the custom firmware 31B is incorporated in the label printer 3B (step S34: YES), as illustrated in FIG. 5A.

Any release or change of the restriction on the changes imposed by the custom firmware 31B through the update of the firmware is not desirable. In other words, the label printer 3B should not perform the process of updating the firmware. In view of this, the CPU 11 groups the label printer 3B into a β group which is distinct from the α group (step S61). As illustrated in FIG. 6A, the CPU 11 displays the label printer 3B in a display area βX together with the check box CH (step S62). The β group is the group to which a label printer 3 configured to perform the process based on the setting command, but not configured to perform the process based on the update command belongs. The β group is an example of a “second group” and a “group C”.

Further, for example, the information on the label printer 3C is stored in the third record of the device table 42 illustrated in FIG. 4. In a case where the CPU 11 extracts the third record, the information “not supportable” is stored in the support information. Therefore, the CPU 11 determines that the label printer 3C does not support the setting command as illustrated in FIG. 5A (step S32: NO). In this case, the CPU 11 determines whether updating the firmware 31C enables the label printer 3C to support the setting command (step S41).

For example, the kitting application 41 accesses a server managed by the vendor providing the kitting application 41 so as to obtain the latest version of the firmware 31 for every model of the label printer 3. Further, the kitting application 41 obtains, from the server, the information indicating whether the latest version supports the predetermined secure level, for every model of the label printer 3. In a case where the latest version of the firmware corresponding to the model name “M0” included in the third record supports the predetermined secure level, and the version “1.1.0” of the firmware 31 included in the third record is older than the latest version of the firmware corresponding to the model “M0”, the CPU 11 determines that the update of the firmware 31C enables the label printer 3C to support the setting command (step S41: YES).

Even in the case of the type of machine which does not support the setting command, updating the custom firmware to any other firmware is undesirable. In view of the above, the CPU 11 determines whether the firmware 31C is the custom firmware, in the same manner as step S34 (step S42).

For example, the version of the firmware 31C stored in the third record illustrated in FIG. 4 does not include the specific letter “S”. Therefore, the CPU 11 determines that the firmware 31C is not the custom firmware (step S42: NO). The CPU 11 groups the label printer 3C into a γ group (step S43). As illustrated in FIG. 6A, the CPU 11 displays the label printer 3C in a display area γX together with the check box CH (step S44). The γ group is the group to which a label printer 3 configured to perform the process based on the update command, but not configured to perform the process based on the setting command belongs. The γ group is an example of a “fourth group” and a “group B”.

Note that in a case where the update of the firmware enables a label printer 3 to support the setting command and where the firmware is the custom firmware (step S42: YES), the CPU 11 groups the label printer 3 into the β group (step S61), and the CPU 11 displays this label printer 3 in the display area βX (step S62). In other words, the update of the firmware 31 is restricted.

Further, for example, the information on the label printer 3D is stored in the fourth record of the device table 42 illustrated in FIG. 4. In a case where the CPU 11 extracts the fourth record, the information “not supportable” is stored in the support information. Therefore, the CPU 11 determines that the label printer 3D is not capable of supporting the setting command as illustrated in FIG. 5A (step S32: NO). In a case where the latest version of the firmware corresponding to the model name “M2” included in the fourth record does not support the predetermined secure level, the CPU 11 determines that the label printer 3D cannot support the setting command even in a case where the firmware 31D of the label printer 3D is updated (step S41: NO). In this case, the CPU 11 determines whether any other program capable of controlling the label printer 3D exists (step S51).

The kitting application 41 accesses the server described above to obtain the program support information which indicates the correspondence between the program for kitting (device setup) and the model name of the label printer 3. The CPU 11 collates the model name “M2” with the program support information. In a case where the program for kitting, which is the program corresponding to the model name “M2” and which is distinct from the kitting application 41, exists, the CPU 11 determines that another program exists (step S51: YES). In this case, the CPU 11 determines whether the another program for kitting, which corresponds to the model name “M2”, has been installed on the PC 1 (step S52).

In a case where the CPU 11 determines that such another program has not been installed yet (step S52: NO), the CPU 11 groups the label printer 3D into a δ group (step S54), and the CPU 11 displays the label printer 3D in a display area δX together with the check box CH (step S56). The δ group is the group to which a label printer 3 which is not configured to perform the process based on the setting command and the process based on the update command, but which is controllable from the PC 1 in a case where the another program different from the kitting application 41 is downloaded to the PC 1 belongs.

In contrast to the foregoing, for example, the information on the label printer 3E is stored in the fifth record of the device table 42 illustrated in FIG. 4. As illustrated in FIG. 5B, in a case where the CPU 11 determines that another program for kitting capable of controlling the label printer 3E exists, based on the support information “not supportable” and the model name “M3” included in the fifth record (step S32: NO, S41: NO, S51: YES), and where the CPU 11 further determines that the another program has been already installed on the PC 1 (step S52: YES), the CPU 11 groups the label printer 3E into an ε group (step S53), and the CPU 11 displays the label printer 3E in the display area δX in the same manner as the label printer 3D belonging to the δ group (step S56). The ε group is the group to which a label printer 3 which is configured not to perform the process based on the setting command and the process based on the update command, but which is controllable from the PC 1 by starting the program installed on the PC 1 distinctly from the kitting application 41 belongs.

Note that, for example, the information on the label printer 3F is included in the sixth record of the device table 42 illustrated in FIG. 4. In a case where another program for kitting, which corresponds to the model name “XY” of the sixth record, is absent (steps S31, S32: NO, S41: NO, step S51: NO), the CPU 11 groups the label printer 3F into a ζ group (step S55), and the CPU 11 displays the label printer 3F in the display area δX in the same manner as the label printer 3D belonging to the δ group (step S56). The ζ group is the group to which a label printer 3 which is not configured to perform the process based on the setting command and the process based on the update command, and which is not controllable from the PC 1 belong. The δ group, the ε group, and the ζ group are each examples of a “third group” and a “group D”.

As illustrated in FIG. 5A, after displaying all of the label printers 3 found by the search in the device list display field SA11 (step S37: YES), the CPU 11 ends the printer display process. Note that in the initial state, the checkbox CH in a non-checked state is displayed for each of the printers found by the search in the device list display field SA11.

With reference to FIG. 3 again, the CPU 11 accepts the selection of the label printer 3 via each of the check boxes CH included in the device list display field SA11 (step S21). Step S21 is an example of a “selection process”. The CPU 11 displays a first operation button SW31, a second operation button SW32, a third operation button SW33, and a fourth operation button SW34 to be operable in an operation button display area SA31 of the device list display screen D11, in accordance with the selection of the label printer(s) 3 (step S22). The first operation button SW31 is an interactive element configured to accept a start instruction for starting the procedure of the setting. The second operation button SW32 is an interactive element configured to accept an update instruction for updating the firmware. The third operation button SW33 is an interactive element configured to accept a download instruction for instructing the PC 11 to download another program. The fourth operation button SW34 is an interactive element configured to accept a start instruction for starting the another program. The kitting application 41 of the present embodiment selects all the label printers 3 found by the search on the device list display screen D11 as the selection targets. However, the kitting application 41 performs exclusive control of the selection target and the display of the operation button, depending on which one of the display areas αX to δX each of the selected label printer 3 belongs to.

For example, the kitting application 41 performs the exclusive control of the selection target and the display of the operation button, depending on the type of label printer which supports the kitting application 41 and the type of label printer which does not support the kitting application 41. As illustrated in FIGS. 6A to 6C, in a case where at least one label printer 3 is selected from the display areas αX, βX, and γX, the check box CH is displayed for each of the label printers 3 in the display areas αX, βX, and γX, whereas the check box CH is not displayed for each of the label printers 3 in the display area δX. In this case, the selected label printer 3 is limited to the label printer 3 which supports both of or one of the setting command and the update command, and another program is unnecessary. Therefore, the third operation button SW33 and the fourth operation button SW34 are disabled. The method of disabling includes, for example, gray-out display, non-display, and no acceptance of operation even if the operation button is displayed.

In contrast, as illustrated in FIGS. 6D and 6E, in a case where at least one of the label printers 3 is selected from the display area δX, the check box CH is displayed for each of the selected label printer 3 in the display area δX, and the check box CH is not displayed for each of the label printers 3 in the display areas αX, βX, and γX. In this case, the selected label printer 3 does not include the label printer 3 which supports both of or one of the setting command and the update command, and another program is required. Therefore, the third operation button SW33 or the fourth operation button SW34 is displayed as enabled, and the first operation button SW31 and the second operation button SW32 are disabled.

Further, in a case where the type of label printer, which supports the kitting application 41, is selected as the control target, the kitting application 41 performs the exclusive control of the selection target and the display of operation button, depending on whether the selected label printer(s) 3 is (are) in the display area βX or γX. As illustrated in FIG. 6B, in a case where at least one of the label printers 3 is selected from the display area βX, the check box CH is displayed for each of the label printers 3 in the display areas αX and βX, and the check box CH is not displayed for each of the label printers 3 in the display areas γX and δX. In this case, the selected label printer(s) 3 is (are) capable of supporting the setting command, but the label printer 3, which is not capable of supporting the update command, is included. Therefore, only the first operation button SW31 is displayed as enabled, and the second to fourth operation buttons SW32 to SW34 are disabled.

In contrast, as illustrated in FIG. 6C, in a case where at least one of the label printer(s) 3 is selected from the display area γX, the check box CH is displayed for each of the label printers 3 in the display areas αX and γX, and the check box CH is not displayed for each of the label printer 3 in the display areas βX and δX. In this case, the selected label printer(s) 3 is (are) capable of supporting the update command, but the label printer 3, which is not capable of supporting the setting command, is included. Therefore, only the second operation button SW32 is displayed as enabled, and the first, third, and fourth operation buttons SW31, SW33, SW34 are disabled.

Note that as illustrated in FIG. 6A, in a case where only the label printers 3 in the display area αX are selected, all of the selected label printers 3 are capable of supporting both the setting command and the update command. Therefore, the first operation button SW31 and the second operation button SW32 are displayed as enabled, and the third operation button SW33 and the fourth operation button SW34 are disabled.

Further, in a case where any type of label printer, which does not support the kitting application 41, is selected as the control target, the kitting application 41 performs the exclusive control of the selection target and the display of operation button, depending on the group to which each of the selected label printer(s) 3 belongs. For example, as illustrated in FIG. 6D, in a case where the label printer 3 belonging to the δ group is selected in the display area δX, the check box CH may be displayed for the label printer 3 belonging to the δ group, and the check box CH may not be displayed for each of the label printer 3 belonging to the ε group and the label printer 3 belonging to the ζ group. In this case, the selected label printer 3 is controllable from the PC 1 on condition that another program is downloaded. Therefore, only the third operation button SW33 is displayed as enabled, and the first, second, and fourth operation buttons SW31, SW32, and SW34 are disabled.

In contrast, as illustrated in FIG. 6E, in a case where the label printer 3 belonging to the ε group is selected in the display area δX, the check box CH is displayed for the selected label printer 3 belonging to the ε group, and the check box CH is not displayed for each of the label printer 3 belonging to the δ group and the label printer 3 belonging to the ζ group. In this case, the selected label printer 3 is controllable by starting another program already installed on the PC 1. Therefore, only the fourth operation button SW34 is displayed as enabled, and the first to third operation buttons SW31 to SW33 are disabled.

Therefore, the kitting application 41 is capable of causing the user to select the label printer 3 so that no inconsistency arises in the supporting of the setting command and the update command. Further, the kitting application 41 is capable of causing the user to operate the operation button(s) appropriate for the selected label printer 3.

With reference to FIG. 3 again, the CPU 11 determines whether the operation is accepted with respect to any one of the first to fourth operation buttons SW31 to SW34 (step S23). In a case where the CPU 11 determines that the operation is accepted (step S23: YES), the CPU 11 performs a process in accordance with the accepted operation (step S24), and the CPU 11 returns the procedure to step S21. The process in accordance with the operation will be described later. In a case where the CPU 11 determines that the operation is not accepted (step S23: NO), the CPU 11 determines whether the end button SW12 on the device list display screen D11 is operated, and whether the end instruction is accepted to end the display of the device list display screen D11 (step S25). In a case where the CPU 11 determines that the end instruction is not accepted (step S25: NO), the CPU 11 returns the procedure to step S21. In a case where the CPU 11 determines that the end instruction is accepted (step S25: YES), the CPU 11 ends the device list display process.

### Setting Process

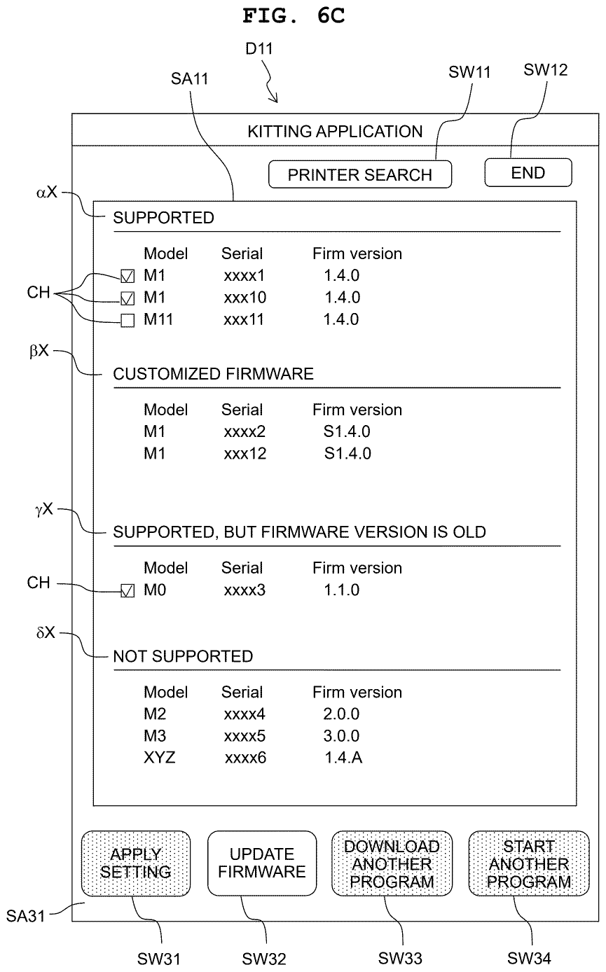

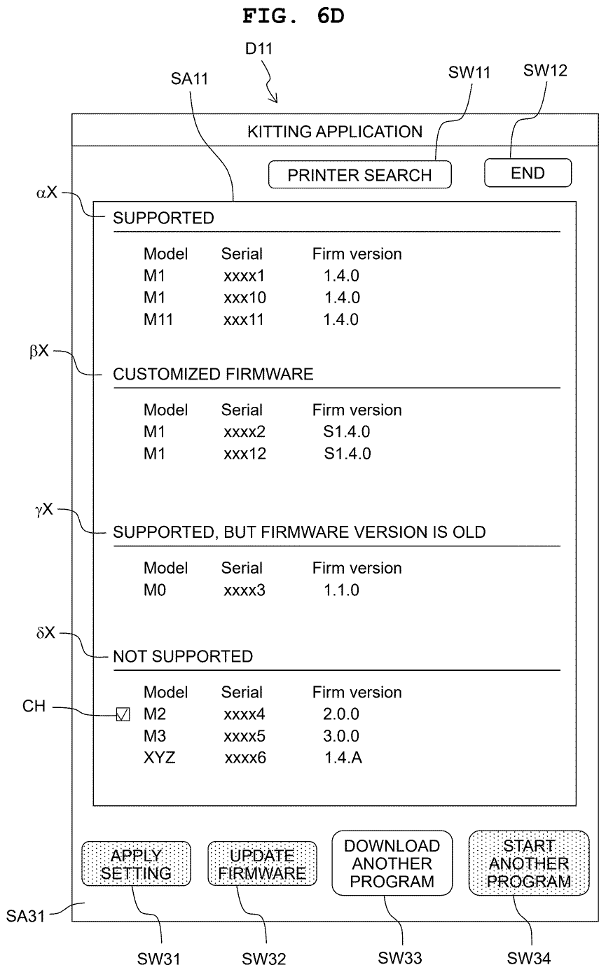

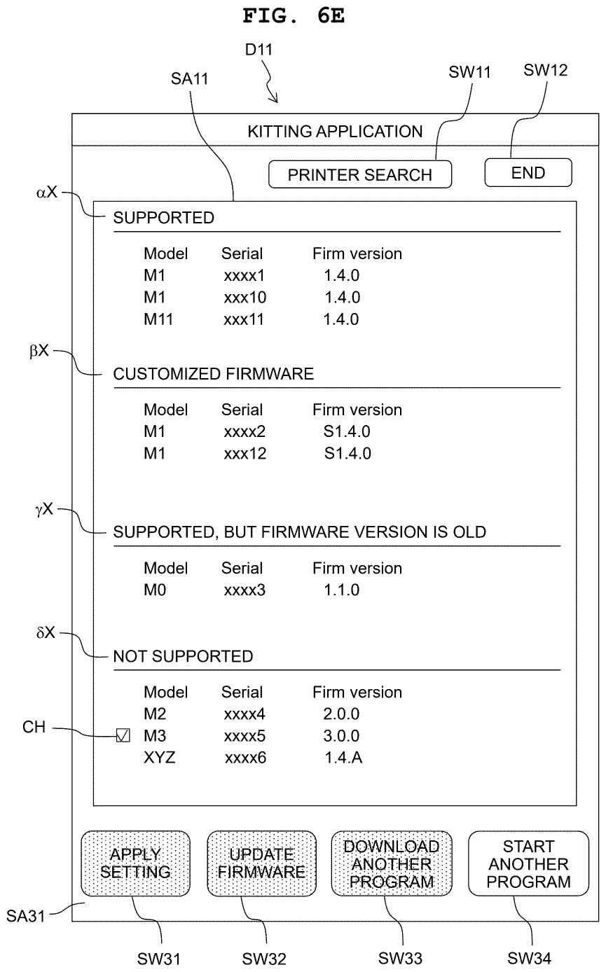

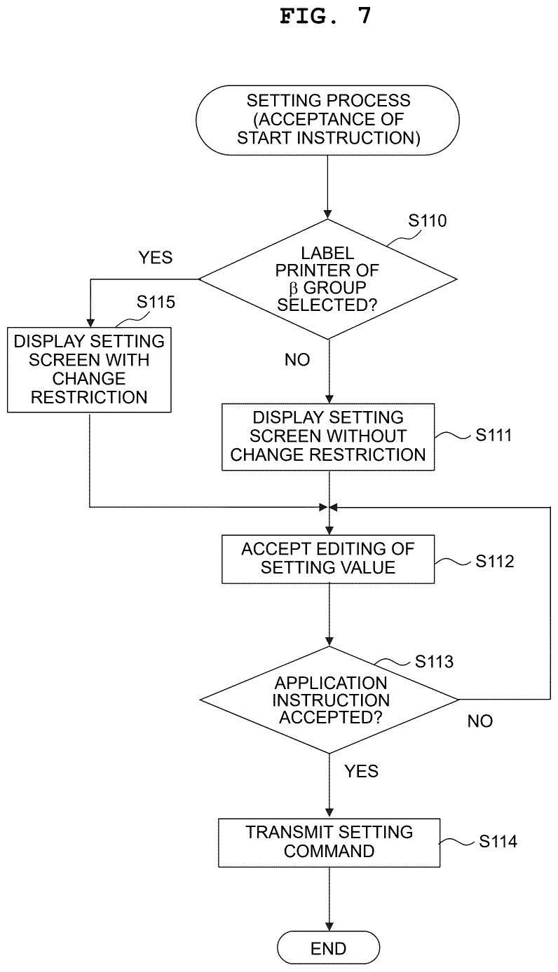

Next, the setting process of setting the setting values for the selected label printer 3 will be described. In a case where the first operation button SW31 is operated, the CPU 11 accepts the start instruction to perform the setting process illustrated in FIG. 7. The process, in which the start instruction is accepted in accordance with the operation of the first operation button SW31, is an example of a “start acceptance process”.

At first, the CPU 11 determines whether the label printer 3 of the β group is selected (step S110). For example, in a case where the first operation button SW31 is operated in a state that only the label printers 3 in the display area αX are selected as illustrated in FIG. 6A, the CPU 11 determines that the label printers 3 of the β group are not selected (step S110: NO), as illustrated in FIG. 7. In this case, the CPU 11 displays the setting screen, without any restriction on the change (step S111), and the CPU 11 proceeds to step S112.

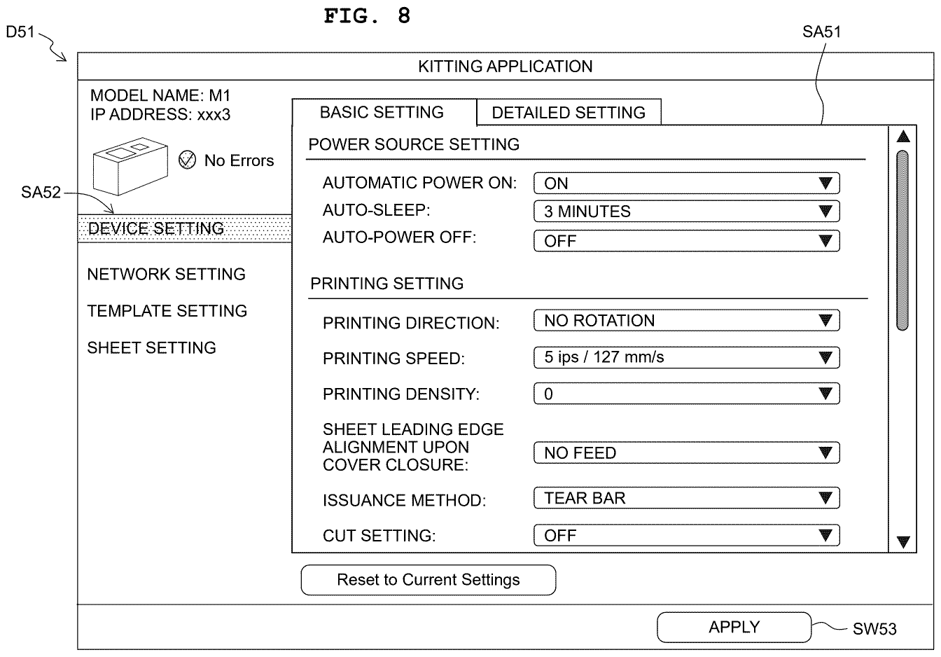

For example, on the setting screen D51 illustrated in FIG. 8, in a case where the main body setting SA52 is selected, a setting value editing field SA51 and an application button SW53 are displayed. In the setting value editing field SA51, the editing of the setting value can be accepted for the items settable by the setting command. The application button SW53 is an interactive element configured to accept the application instruction.

In a case where the label printers 3 of the β group are not selected, the CPU 11 causes the user interface I/F 13 to display the setting screen D51 so that the setting values can be accepted, by all of the selected label printers 3, within a range in which all items settable by the setting command can be set.

On the other hand, in a case where the first operation button SW31 is operated in a state that the selected label printers 3 include the label printer 3 in the display area βX as illustrated in FIG. 6B, the CPU 11 determines that the label printer 3 of the β group is selected (step S110: YES) as illustrated in FIG. 7, and the CPU 11 causes the user interface I/F 13 to display the setting screen, with the restriction on the change (step S115). After that, the CPU 11 proceeds to step S112.

That is, the CPU 11 causes the user interface I/F 13 to display the setting screen D51 so that the editing cannot be accepted for the setting value restricted with respect to the label printer 3 selected in the display area βX. For example, in a case where the label printer 3, which is selected in the display area βX, is prohibited to perform any operation with respect to the item of “printing density”, the CPU 11 causes the user interface I/F 13 to display the item of the printing density and the setting value setting field in a gray out manner. Further, for example, in a case where a fixed value is set for the auto-sleep, the CPU 11 causes the user interface I/F 13 to display a fixed value in the setting value setting field of the auto-power off such that any other setting value cannot be selected from a pull-down menu.

After causing the user interface I/F 13 to display the setting screen D51 in step S111 or step S115, the CPU 11 accepts the editing of the setting value(s) via the setting screen D51 (step S112). The CPU 11 determines whether the application instruction is accepted (step S113). The CPU 11 accepts the editing of the setting values until the application instruction is accepted in accordance with the operation of the application button SW53 (step S113: NO). In a case where the application button SW53 is operated and where the application instruction is accepted (step S113: YES), the CPU 11 uses the communication I/F 14 to transmit the setting command based on the setting value(s) edited in the setting value editing field SA51 to the label printer(s) 3 selected on the device list display screen D11 by (step S114), and the CPU 11 ends the setting process. The steps S111, S112, and S113 are examples of a “setting acceptance process”. The step S114 is an example of a “transmittance process”.

The label printer 3, upon receiving the setting command, sets the setting value(s) included in the setting command. Even in a case where the label printer 3 of the β group is selected, the kitting application 41 accepts the editing of the setting value(s) within a range in which the setting value(s) for all of the label printer(s) 3 selected in the β group can be set, and the kitting application 41 transmits the setting command to the selected label printer(s) 3. Therefore, the appropriate setting values are collectively set for the selected label printer(s) 3.

Further, in a case where the kitting application 41 sets the same setting values for the label printers 3 of the α group and the label printers 3 of the β group, the kitting application 41 is capable of transmitting the setting command collectively from the PC 1 to the selected label printers 3 in a case where the application button SW53 is operated one time. Therefore, the number of times of operation can be reduced, and the convenience can be improved.

### Update Process

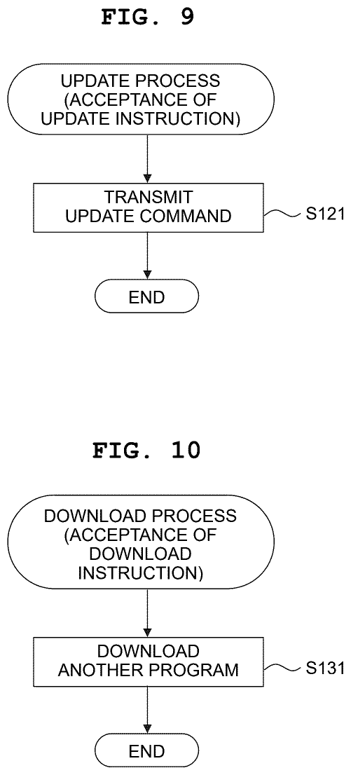

Next, the update process of transmitting the update command to the label printer 3 to update the firmware will be described. In a case where the second operation button SW32 is operated, the CPU 11 accepts the update instruction, and the CPU 11 performs the update process illustrated in FIG. 9. The process of accepting the update instruction in accordance with the operation of the second operation button SW32 is an example of an “update acceptance process” and a “firmware group update acceptance process”.

The CPU 11 uses the communication I/F 14 to transmit the update command to the label printer(s) 3 selected on the device list display screen D11 (step S121). The step S121 is an example of a “firmware update process” and a “firmware group update process”. After that, the CPU 11 ends the update process.

In a case where the latest firmware exists, the label printer 3, upon receiving the update command, obtains the latest firmware from the server, and the label printer 3 updates the existing firmware to the latest firmware. Accordingly, for example, the firmware is updated even in a certain label printer 3 of the γ group, and the certain label printer 3 of the γ group is enabled to support the setting command. In the next printer search performed by the kitting application 41, the certain label printer 3 is grouped into the α group, and is displayed in the display area αX.

Further, in a case where the firmware is updated for the label printer 3 of the α group and the label printer 3 of the γ group, the kitting application 41 is capable of transmitting the update command collectively from the PC 1 to the selected label printers 3 in a case where the second operation button SW32 is operated one time in a state that the label printers 3 in the display areas αX, γX are selected. Therefore, the number of times of operation can be reduced, and the convenience can be improved.

### Download Process

Next, the process of downloading another program will be described. In a case where the third operation button SW33 is operated, the CPU 11 accepts the download instruction, and the CPU 11 performs the download process illustrated in FIG. 10. The process of accepting the download instruction in accordance with the operation of the third operation button SW33, is an example of a “download acceptance process”.

The CPU 11, upon accepting the download instruction, performs the process of downloading another program (step S131), and the CPU 11 ends the download process. For example, the CPU 11 starts a browser to display a site from which the another program can be downloaded. The user selects, in the displayed site, a necessary program (for example, a program for kitting supported by the label printer 3D), and the user downloads the program to the PC 1. Note that the CPU 11, upon accepting the download instruction, may automatically access, for example, the site to download the another program to the PC 1. Accordingly, the download of the another program for kitting is facilitated.

### Start Process

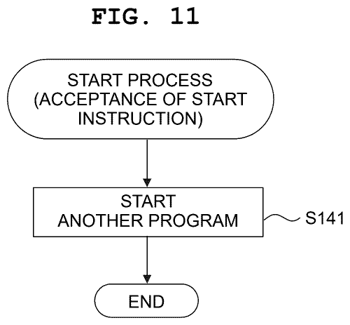

Next, the start process of starting another program will be described. In a case where the fourth operation button SW34 is operated, the CPU 11 accepts the start instruction, and the CPU 11 performs the start process illustrated in FIG. 11. The process of accepting the start instruction in accordance with the operation of the fourth operation button SW34 is an example of the “start acceptance process”.

The CPU 11 reads, for example, another program for kitting stored in the memory 12, and the CPU 11 starts the another program (step S141). After that, the CPU 11 ends the start process. Accordingly, the facilitation of the utilization of the another program can be expected.

Some label printers 3, among the label printers 3, are not enabled to change at least some of the setting items, for example, as in the custom firmware. The kitting application 41 of the first embodiment groups and displays such a label printer 3 as described above distinctly from the label printer 3 in which the change is not restricted and the label printer 3 which does not support the setting command. Accordingly, the user can recognize the presence of the label printer 3 in which the change is restricted.

Further, some label printers 3, among the label printers 3, are not capable of supporting the setting command due to the old version of the firmware 31. Such a label printer 3 as described above can support the setting command through the update of the firmware 31. The kitting application 41 of the first embodiment groups and displays such a label printer 3 as a label printer 3 other than the label printer 3 which supports the setting command and the label printer 3 which does not support the setting command. Accordingly, the kitting application 41 of the first embodiment can be expected to prompt the user to update the firmware with respect to the label printer 3 which can support the setting command through the update of the firmware 31.

### Second Embodiment

Next, a program according to a second embodiment will be described. A kitting application 41 of the second embodiment displays, on the user I/F 13, a device list display screen D11x in which an operation button is disposed in each of the display areas αX to δX. This feature of the second embodiment is different from the feature of the first embodiment of displaying the device list display screen D11 in which the operation button is not disposed in each of the display areas αX to δX. The features of the second embodiment, which are different from the features of the first embodiment, will be mainly described below, whereas the features of the second embodiment common to the feature of the first embodiment common features are designed by the same reference numerals as the reference numerals of the first embodiment in the drawings and the description, and any detailed explanation will be omitted as appropriate.

### Device List Display Process

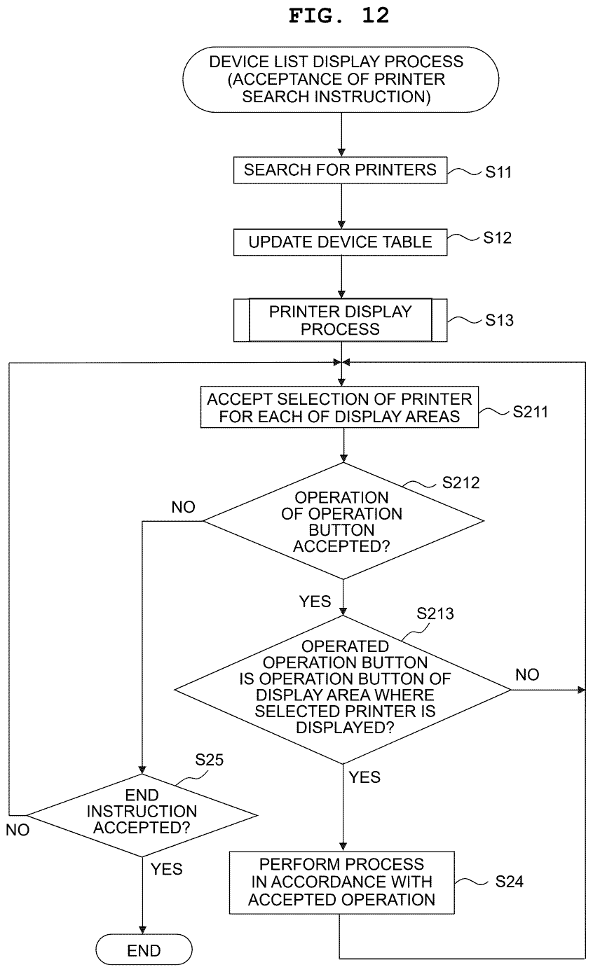

The CPU 11 uses the kitting application 41 of the second embodiment to perform a device list display process illustrated in FIG. 12. The CPU 11, upon accepting the printer search instruction, displays the label printers 3 found by the printer search on the device list display screen D11x, in the same manner as the first embodiment (step S11 to S13). The group, in which no printer is found, may not be displayed on the device list display screen D11x. For example, in a case where the label printer 3 of the β group is not found by the printer search, the display area βX may not be displayed.

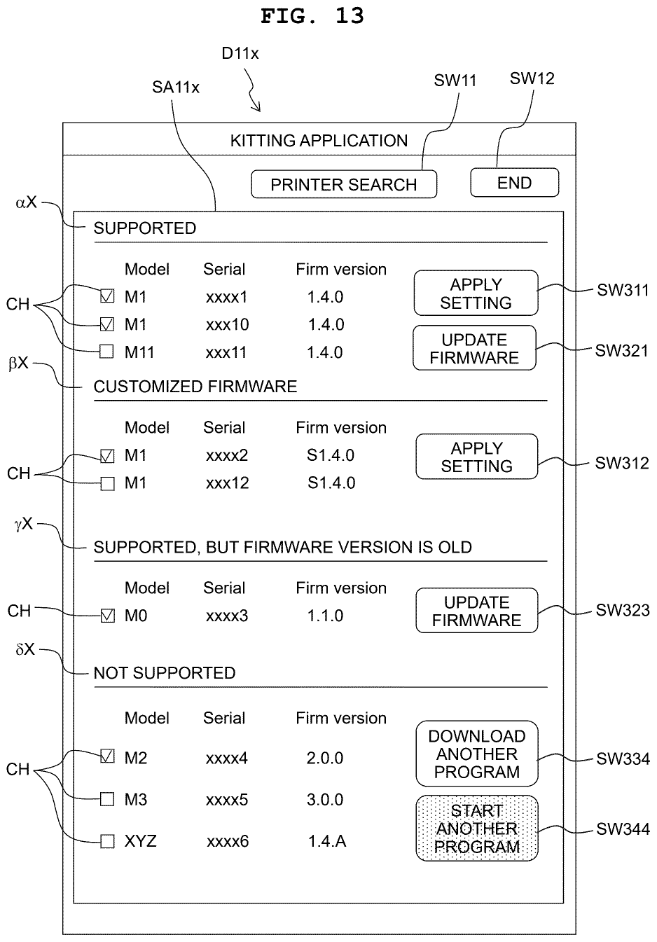

In the second embodiment, as illustrated in FIG. 13, the label printers 3, which support both the setting command and the update command, are displayed as the selection targets in the display area αX. Therefore, a first operation button SW311 and a second operation button SW321 are displayed as enabled in the display area αX. The label printer 3, which supports the setting command but does not support the update command, is displayed as the selection target in the display area βX. Therefore, only a first operation button SW312 is displayed in the display area βX. The label printers 3, which support the update command but do not support the setting command, are displayed as the selection targets in the display area γX. Therefore, only a second operation button SW323 is displayed in the display area γX. The label printers 3, which does not support the setting command and the update command, are displayed as the selection targets in the display area δX. Therefore, a third operation button SW334 and a fourth operation button SW344 are displayed in the display area δX. Note that the display of the third operation button SW334 and the display of the fourth operation button SW344 may be switched depending on the group to which the label printer(s) 3 selected in the display area δX belong(s).

As illustrated in FIG. 12, the CPU 11 accepts the selection of the label printer(s) 3 for each of the display areas αX to δX (step S211). In the second embodiment, as illustrated in FIG. 13, the label printer(s) 3 can be simultaneously selected in each of the display areas αX to δX. However, the following procedure may also be possible. That is, in a case where the label printer 3 is selected in any one of the display areas αX to δX (for example, the display area αX), the selection of the label printer 3 is not accepted in the display area (for example, the display areas βX to δX) in which the label printer(s) 3 is (are) not selected. The process of S211 is an example of a “group-based selection process”.

The CPU 11 determines whether the operation of the operation button is accepted (step S212). In a case where the CPU 11 determines that the operation of the operation button is not accepted (step S212: NO), the CPU 11 determines whether the end button SW12 of the device list display screen D11x is operated and the end instruction is accepted (step S25). In a case where the CPU 11 determines that the end instruction is not accepted (step S25: NO), the CPU 11 returns the procedure to step S211. In a case where the CPU 11 determines that the end instruction is accepted (step S25: YES), the CPU 11 ends the device list display process.

In a case where the CPU 11 determines that the operation of the operation button is accepted (step S212: YES), the CPU 11 determines whether the operated operation button is the operation button in the display area in which the selected label printer(s) 3 is (are) displayed (step S213). For example, in a case where the first operation button SW311 in the display area αX is operated in a state that the label printer(s) 3 in the display area αX is (are) not selected, the CPU 11 determines that the operated operation button is not the operation button in the display area in which the selected printer(s) is (are) displayed (step S213: NO), and the CPU 11 returns the procedure to step S211.

In contrast, for example, in a case where the first operation button SW311 of the display area αX is operated in a state that the label printers 3 in the display area αX are selected, the CPU 11 determines that the operated operation button is the operation button of the display area in which the selected printer(s) is (are) displayed (step S213: YES), and the CPU 11 performs the process in accordance with the accepted operation (the setting process in a case where the first operation button SW311 is operated). Then, the CPU 11 returns the procedure to step S211.

Note that the following procedure is also possible. That is, the first to fourth operation buttons SW311, SW312, SW321, SW323, SW334, and SW344 may be configured not to accept the instruction in a state that no label printers 3 are selected in the display areas αX to δX.

### Setting Process

For example, in a case where the user intends to perform the same setting with respect to the label printers 3 of the α group and the β group, the label printers 3 are selected from the display areas αX, βX as illustrated in FIG. 13. As the user operates the first operation button SW311 in the display area αX, the CPU 11 accepts the start instruction, and the CPU 11 performs the setting process illustrated in FIG. 7. The CPU 11 causes the user I/F 13 to display the setting screen D51 without any restriction on the change (step S110: NO, S111), and the CPU 11 accepts the editing of the setting value(s) (step S112). As the application button SW53 is operated and the application instruction is accepted (step S113: YES), the CPU 11 transmits the setting command based on the setting value(s) edited on the setting screen D51 to the label printers 3 selected in the display area αX (step S114).

After that, as the user further operates the first operation button SW312 in the display area βX, the CPU 11 accepts the start instruction, and the CPU 11 performs the setting process illustrated in FIG. 7. The CPU 11 causes the user I/F 13 to display the setting screen D51 with the restriction on the change (step S110: YES, S115), and the CPU 11 accepts the editing of the setting value(s) (step S112). As the application button SW52 is operated and the application instruction is accepted (step S113: YES), the CPU 11 transmits the setting command based on the setting value(s) edited on the setting screen D51 to the label printer 3 selected in the display area βX (step S114). Note that the process, in which the CPU 11 accepts the start instruction in accordance with the operation of the first operation button SW311 or SW312, is an example of a “group-based start acceptance process”. The process of the step S112 is an example of the “group-based setting acceptance process”. The step S114 is an example of a “group-based transmittance process”.

The kitting application 41 of the second embodiment accepts the application instruction for each of the α group and the β group. Therefore, the setting is easily applied while distinguishing the label printer 3 in which the change is restricted from the label printer 3 in which the change is not restricted. In other words, even in a case where the first operation button SW311 is operated in a state that a certain label printer 3 of the β group is selected on the device list display screen D11x, the setting is not applied to the certain label printer 3 belonging to the β group.

As described above, the kitting application 41 of the second embodiment accepts the selection of the label printers 3 and the start instruction for each of the α group and the β group. Therefore, the kitting application 41 of the second embodiment is capable of accepting the setting values within a range in which the setting can be performed appropriately for each of the groups, and is capable of transmitting the setting command. Thus, the kitting application 41 of the second embodiment is capable of transmitting the setting command with which the appropriate setting value(s) is (are) set with respect to the selected label printer(s) 3 for each of the groups.

### Update Process

For example, in a case where the user intends to update the firmware for the label printers 3 of the α group and the γ group, the user selects the label printers 3 from the display areas αX and γX as illustrated in FIG. 13. As the user operates the second operation button SW321 in the display area αX, the CPU 11 accepts the update instruction, and the CPU 11 performs the update process illustrated in FIG. 9. The CPU 11 transmits the update command to the label printers 3 selected in the display area αX (step S121).

After that, as the user further operates the second operation button SW323 in the display area γX, the CPU 11 accepts the update instruction, and the CPU 11 performs the update process illustrated in FIG. 9. The CPU 11 transmits the update command to the label printer 3 selected in the display area γX (step S121). Note that the process, in which the CPU 11 accepts the update instruction in accordance with the operation of the second operation button SW321 or SW323, is an example of a “group-based update acceptance process” and a “firmware group update acceptance process”. The process of S121 is an example of a “group-based firmware update process” and a “firmware group update process”.

As described above, the kitting application 41 of the second embodiment accepts the update instruction for each of the α group and the γ group. Therefore, the user can distinguish the label printer 3 which can support the setting command through the update of the firmware 31, and the user can update the firmware of the label printer 3.

Note that the embodiments disclosed in the present specification are merely examples, and do not limit the present disclosure in any way. Therefore, various improvements and changes may be made for the technique disclosed in the specification without departing from the spirit and scope of the present disclosure.

In the first embodiment as described above, whether the operation button is enabled or disabled is switched in accordance with the selection of the label printer 3. Alternatively, the label printer(s) 3, which is (are) to be selected in accordance with the operation of the operation button, may be limited. For example, in a case where the kitting application 41 causes the first to fourth operation buttons SW31 to SW34 to be displayed as enabled on the device list display screen D11, and where the kitting application 41 accepts the operation of the first operation button SW31, the kitting application 41 may make the label printers 3 displayed in the display areas αX, βX the selection targets, and the kitting application 41 may exclude the label printers 3 displayed in the display areas γX, δX from the selection targets.

For example, in the second embodiment described above, the label printers 3, which are searched by the printer search, are displayed so that the label printers 3 are included in one device list display screen D11x. However, the kitting application 41 may prepare the screen for each of the groups, and the kitting application 41 may switch between the screens based on the groups. In this case, the operation button(s) may be displayed as enabled, based on the characteristic of the group.

For example, the kitting application 41 may not accept the update instruction with respect to the label printer 3 of the γ group. Note, however, that in a case where the kitting application 41 is configured to accept the printer selection not only for the label printers 3 grouped into the α group but also for the label printers 3 grouped into the γ group, the kitting application 41 may transmit the update command for the firmware to the label printer 3 which requires the firmware update. With this, the possibility that the label printer 3 can support the setting command is raised.

For example, the third and fourth operation buttons SW33, SW34, SW334, SW344 may be omitted, and a notification process of notifying the user of the utilization of another program may be omitted.

For example, the steps S34, S61, and S62 illustrated in FIG. 5A may be omitted. In other words, the kitting application 41 may group the label printers 3 found by the printer search depending on whether the update of the firmware is required, and the kitting application 41 may display the grouped label printers 3 on the device list display screen D11.

The type of letter for distinguishing the custom firmware and the method for distinguishing the custom firmware may be different from the letter and the method described in the embodiments.

Further, in any one of the flow charts described in the embodiments, the order of performing the plurality of processes in any number of steps may be changed in any way, or a plurality of processes in any number of steps may be executed in parallel, as long as no conflict arises in the contents of the processes.

Furthermore, the processes described in the embodiments may be performed by a single CPU, a plurality of CPUs, hardware such as an ASIC, or any combination of the CPU(s) and ASIC(s). Further, the processes disclosed in the embodiments may be realized in various kinds of aspects including, for example, a storage medium storing a program to perform the processes, and a method of performing the processes.

### Addendum

A person skilled in the art would appreciate that some aspects of the above-described embodiments and modifications are specific examples of the following aspects.

A non-transitory medium storing a program executable by an information processing apparatus, the program having a setting function to cause the information processing apparatus to transmit a setting command with respect to a plurality of image processing apparatuses connected via a communication interface of the information processing apparatus, the setting command being a command to set setting values for a plurality of items, wherein the program causes the information processing apparatus to perform:
a search process of searching for the plurality of image processing apparatuses via the communication interface of the information processing apparatus; and
a display process of grouping the plurality of image processing apparatuses found by the search process into a first group, a third group, and a fourth group and causing a user interface of the information processing apparatus to display the plurality of image processing apparatuses which have been grouped,
wherein image processing apparatuses belonging to the first group support the setting command,
image processing apparatuses belonging to the third group do not support the setting command, and
image processing apparatuses belonging to the fourth group do not currently support the setting command but support the setting command through an update of firmware.

A non-transitory medium storing a program executable by an information processing apparatus, the program having a function to cause the information processing apparatus to transmit a first control command and a function to cause the information processing apparatus to transmit a second control command, with respect to a plurality of image processing apparatuses connected via a communication interface of the information processing apparatus, wherein the program causes the information processing apparatus to perform:
a search process of searching for the plurality of image processing apparatuses via the communication interface of the information processing apparatus; and
a command support-based display process of grouping the plurality of image processing apparatuses found by the search process into a group A, a group B, a group C, and a group D and causing a user interface of the information processing apparatus to display the plurality of image processing apparatuses which have been grouped,
wherein image processing apparatuses belonging to the group A support both the first control command and the second control command,
image processing apparatuses belonging to the group B support the second control command but do not support the first control command,
image processing apparatuses belonging to the group C support the first control command but do not support the second control command, and
image processing apparatuses belonging to the group D do not support both the first control command and the second control command.

A display method for causing a user interface of an information processing apparatus to display a list of a plurality of image processing apparatuses connected via a communication interface of the information processing apparatus, a program being installed on the information processing apparatus, the program having a setting function to cause the information processing apparatus to transmit a setting command with respect to the plurality of image processing apparatuses connected via the communication interface of the information processing apparatus, the setting command being a command to set setting values for a plurality of items, the display method comprising:
searching for the plurality of image processing apparatuses connected via the communication interface of the information processing apparatus;
grouping the plurality of image processing apparatuses found by searching for the plurality of image processing apparatuses into a first group, a third group, and a fourth group; and
displaying the plurality of image processing apparatuses which have been grouped,
wherein image processing apparatuses belonging to the first group support the setting command,
image processing apparatuses belonging to the third group do not support the setting command, and
image processing apparatuses belonging to the fourth group do not currently support the setting command but support the setting command through an update of firmware.

What is claimed is:

1. A non-transitory medium storing a program executable by an information processing apparatus, the program having a setting function to cause the information processing apparatus to transmit a setting command with respect to a plurality of image processing apparatuses connected via a communication interface of the information processing apparatus, the setting command being a command to set setting values for a plurality of items, wherein the program causes the information processing apparatus to perform:
a search process of searching for the plurality of image processing apparatuses via the communication interface of the information processing apparatus; and
a display process of grouping the plurality of image processing apparatuses found by the search process into a first group, a second group, and a third group and causing a user interface of the information processing apparatus to display the plurality of image processing apparatuses which have been grouped,
wherein image processing apparatuses belonging to the first group support the setting command,
image processing apparatuses belonging to the second group support the setting command and restrict changing at least a part of the plurality of items settable by the setting command, and
image processing apparatuses belonging to the third group do not support the setting command.

2. The medium according to claim 1, wherein the program causes the information processing apparatus to perform:
a selection process of accepting, via the user interface of the information processing apparatus, selection of at least one image processing apparatus of the plurality of image processing apparatuses found by the search process; and
a start acceptance process of accepting, via the user interface of the information processing apparatus, a start instruction to start a procedure for setting the setting values,
the program causes the information processing apparatus to perform a setting acceptance process of accepting, via the user interface of the information processing apparatus, editing of the setting values and an application instruction of the setting values, in a case where the information processing apparatus accepts the start instruction in a state that at least one image processing apparatus of the image processing apparatuses grouped into the first group or the second group is selected, the editing of the setting values being acceptable within a range in which the setting can be performed in all of the at least one image processing apparatus selected, in a state that the at least one image processing apparatus of the image processing apparatuses grouped into the second group is selected, and
the program causes the information processing apparatus to perform a transmittance process of causing the information processing apparatus to transmit the setting command based on the edited setting values with respect to the at least one image processing apparatus which has been selected, in a case where the information processing apparatus accepts the application instruction.

3. The medium according to claim 2, wherein the program causes the information processing apparatus to perform an update acceptance process of accepting an update instruction of firmware via the user interface of the information processing apparatus in a state that an image processing apparatus, which is included in the plurality of image processing apparatuses found by the search process and of which firmware can be updated, is selected, and
the program causes the information processing apparatus to perform a firmware update process of causing the information processing apparatus to transmit an update command for the firmware with respect to the selected image processing apparatus, in a case where the information processing apparatus accepts the update instruction.

4. The medium according to claim 3, wherein in the update acceptance process, the update instruction for updating the firmware is accepted via the user interface of the information processing apparatus in a state that an image processing apparatus, included in the plurality of image processing apparatuses found by the search process and capable of performing a process corresponding to the update command, is selected as the image processing apparatus of which firmware can be updated.

5. The medium according to claim 3, wherein in the update acceptance process, the update instruction for updating the firmware is accepted via the user interface of the information processing apparatus in a state that a certain image processing apparatus is selected as the image processing apparatus of which firmware can be updated, the certain image processing apparatus being included in the plurality of image processing apparatuses found by the search process and supporting newer version of firmware currently incorporated in the certain image processing apparatus.

6. The medium according to claim 1, wherein the program causes the information processing apparatus to perform:
a group-based selection process of accepting, via the user interface of the information processing apparatus, selection of at least one image processing apparatus of the plurality of image processing apparatuses found by the search process, for each of the first to third groups; and
a group-based start acceptance process of accepting, via the user interface of the information processing apparatus, a start instruction to start a procedure of setting the setting values, for each of the first and second groups, and of not accepting the start instruction for the third group,
the program causes the information processing apparatus to perform a group-based setting acceptance process of accepting editing of the setting values and an application instruction of the setting values via the user interface of the information processing apparatus, in a case where the information processing apparatus accepts the start instruction corresponding to each of the first to third groups, in a state that with respect to each of the first to third group, at least one image processing apparatus of the image processing apparatuses grouped into each of the first to third groups is selected, the editing of the setting values being acceptable within a range in which the setting can be performed in all of the at least one image processing apparatus selected in the second group in a case where the start instruction corresponding to the second group is accepted, and
the program causes the information processing apparatus to perform a group-based transmittance process of causing the information processing apparatus to transmit the setting command based on the edited setting values to the at least one image processing apparatus selected in each of the first to third groups in a case where the information processing apparatus accepts the application instruction corresponding to each of the first to third groups.

7. The medium according to claim 6, wherein the program causes the information processing apparatus to perform:
a group-based update acceptance process of accepting, via the user interface of the information processing apparatus, an update instruction of firmware with respect to the first group and of not accepting the update instruction with respect to the second group and the third group; and
a group-based firmware update process of causing the information processing apparatus to transmit an update command for updating the firmware with respect to the at least one image processing apparatus selected in the first group, in a case where the information processing apparatus accepts the update instruction.

8. The medium according to claim 1, wherein in the display process, the program causes the user interface of the information processing apparatus to display the plurality of image processing apparatuses found by the search process, in a state that the plurality of image processing apparatuses are grouped into the image processing apparatuses belonging to the first group, the image processing apparatuses belonging to the second group, the image processing apparatuses belonging to the third group, and image processing apparatuses belonging to a fourth group, and
the image processing apparatuses belonging to the fourth group do not currently support the setting command but support the setting command through an update of firmware.

9. The medium according to claim 8, wherein the program causes the information processing apparatus to perform a selection process of accepting, via the user interface of the information processing apparatus, selection of at least one image processing apparatus of the plurality of image processing apparatuses found by the search process, and
the program causes the information processing apparatus to further perform:
a firmware group update acceptance process of accepting an update instruction of firmware via the user interface of the information processing apparatus, in a state that at least one image processing apparatus of the plurality of image processing apparatuses, of which firmware is required to be updated, is selected; and
a firmware group update process of causing the information processing apparatus to transmit an update command for the firmware with respect to the at least one image processing apparatus which has been selected, in a case where the information processing apparatus accepts the update instruction.

10. The medium according to claim 1, wherein the program causes the information processing apparatus to perform a notification process of notifying a user of use of another program via the user interface of the information processing apparatus, in a case where the image processing apparatuses grouped into the third group are present, and the another program, capable of controlling the image processing apparatuses grouped into the third group, exists.

11. The medium according to claim 10, wherein the program causes the information processing apparatus to perform a start acceptance process of accepting a start instruction for the another program via the user interface of the information processing apparatus, in a case where the image processing apparatuses grouped into the third group are present, and where the another program has already been installed on the information processing apparatuses, and
the program causes the information processing apparatus to start the another program, in a case where the information processing apparatus accepts the start instruction.

12. The medium according to claim 11, wherein the program causes the information processing apparatus to perform:
a download acceptance process of accepting a download instruction for the another program via the user interface of the information processing apparatus, in a case where the image processing apparatuses grouped into the third group are present, and where the another program is not installed on the information processing apparatuses; and
a process of downloading the another program in a case where the information processing apparatus accepts the download instruction.

13. A display method for causing a user interface of an information processing apparatus to display a list of a plurality of image processing apparatuses connected via a communication interface of the information processing apparatus, the display method comprising:
searching for the plurality of image processing apparatuses connected via the communication interface of the information processing apparatus;
grouping the plurality of image processing apparatuses found by searching for the plurality of image processing apparatuses into a first group, a second group, and a third group; and
displaying the plurality of image processing apparatuses which have been grouped,
wherein image processing apparatuses belonging to the first group support a setting command to set setting values for a plurality of items,
image processing apparatuses belonging to the second group support the setting command and restrict changing at least a part of the plurality of items settable by the setting command, and
image processing apparatuses belonging to the third group do not support the setting command.

14. A display method for displaying, on a display of an information processing apparatus, a list of a plurality of image processing apparatuses connected via a communication interface of the information processing apparatus, the display method comprising:
searching for the plurality of image processing apparatuses connected via the communication interface of the information processing apparatus;
displaying image processing apparatuses belonging to a group A in an area A on the display of the information processing apparatus, the image processing apparatuses belonging to the group A supporting both first control command and second control command;
displaying image processing apparatuses belonging to a group B in an area B on the display of the information processing apparatus, the image processing apparatuses belonging to the group B supporting the second control command but not supporting the first control command;
displaying image processing apparatuses belonging to a group C in an area C on the display of the information processing apparatus, the image processing apparatuses belonging to the group C supporting the first control command but not supporting the second control command; and
displaying image processing apparatuses belonging to a group D in an area D on the display of the information processing apparatus, the image processing apparatuses belonging to the group D not supporting either the first control command or the second control command.
